(19) United States
(12) Patent Application Publication
(10) Pub. No.: US 2012/0264493 A1
(43) Pub. Date: Oct. 18, 2012

(54) Twin Straw Chopper

(75) Inventors: Robert A. Matousek, Valley Center, KS (US); Joshua J. Wolters, Atwood, KS (US)

(73) Assignee: AGCO CORPORATION, Duluth, GA (US)

(21) Appl. No.: 13/324,314

(22) Filed: Dec. 13, 2011

Related U.S. Application Data
(60) Provisional application No. 61/422,347, filed on Dec. 13, 2010.

(51) Int. Cl. A01F 12/40

(52) U.S. Cl. 460/112

(57) ABSTRACT

In one embodiment, a straw chopper apparatus of a combine harvester, the straw chopper apparatus comprising plural chopper rotors disposed proximally to a rearward end of the combine harvester, each of the chopper rotors comprising a shaft having an axis of rotation substantially parallel to the direction of travel, the shaft having a length dimension and a diameter dimension, the length dimension greater than the diameter dimension, the shaft comprising plural sets of blades that are pivotably coupled to the shaft.

### TECHNICAL FIELD

The present disclosure generally relates to a combine harvester, residue chopping apparatus.

### BACKGROUND

Combine harvesters (or also referred to simply as combines) today are complex machines used in the harvesting and threshing of a variety of crops. Combine harvesters typically comprise a chopping assembly, which may include rotating knives or blades located toward the rearward end of the combine harvester, the chopping assembly receiving residue (e.g., material other than grain, such as straw), among possibly other material, from a thresher rotor assembly of the combine harvester. The chopping assembly chops and spreads the chopped residue on the ground as the combine harvester travels through a crop field.

### SUMMARY

In one embodiment, a straw chopper apparatus of a combine harvester, the straw chopper apparatus comprising plural chopper rotors disposed proximally to a rearward end of the combine harvester, each of the chopper rotors comprising a shaft having an axis of rotation substantially parallel to the direction of travel, the shaft having a length dimension and a diameter dimension, the length dimension greater than the diameter dimension, the shaft comprising plural sets of blades that are pivotably coupled to the shaft.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example combine harvester in which an embodiment of a straw chopper apparatus may be employed.

FIG. 2 is a partial rear elevation view of an example combine harvester that illustrates an embodiment of a straw chopper apparatus and in particular, an example housing of the straw chopper apparatus.

FIG. 3 is a partial rearward perspective view of an embodiment of a straw chopper apparatus located relative to a portion of an example thresher rotor apparatus.

FIG. 4 is a block diagram that illustrates a cutaway, partial rear elevation view of portions of an embodiment of a straw chopper apparatus comprising plural rotors.

FIG. 5 is a schematic diagram of an embodiment of an example rotor illustrating sets of blades.

FIG. 6 is a block diagram that illustrates a partial cutaway side elevation view of an embodiment of portions of a straw chopper apparatus having an example fan apparatus disposed between a cleaning apparatus and the front of plural rotors.

FIG. 7 is a flow diagram that illustrates an embodiment of a straw chopper method.

### DETAILED DESCRIPTION

Certain embodiments of a straw chopper apparatus and method for use in a combine harvester are disclosed. In one embodiment, a straw chopper apparatus comprises plural rotors, where each rotor has an axis generally or substantially parallel to the direction of travel of the combine harvester (e.g., parallel to a longitudinal axis of the combine separator). For instance, some embodiments of the straw chopper apparatus may be arranged at the same or substantially the same angle (e.g., relative to a horizontal axis coincident with the longitudinal axis of the combine separator) as the combine rotor(s) (or equivalently, the thresher rotor(s) of the combine harvester), circumventing the need to transmit power (e.g., from the power take-off (PTO)) through an angular (bevel) gear to power either of the chopper rotors. Note that in some embodiments, an angular gear may be used to transmit power to the rotors. The straw chopper apparatus may be enclosed (at least partially) in a housing or enclosure that has a wide inlet located, in some embodiments, directly beneath the thresher rotor(s) of a thresher rotor apparatus, and one or more outlets located proximal to the lower end of the housing, enabling disbursement of the chopped material directly to the ground over the full width of the combine header. Some embodiments further include a fan apparatus that receives, for instance, chaff from the cleaning system components of the combine harvester and influences the flow of the chaff into the straw chopper apparatus.

Digressing briefly, residue (e.g., material other than grain) from threshing operations (e.g., including separating operations) of a combine harvester is chopped and spread by a chopper assembly behind the width of a combine header. In some chopper assemblies, such as a hood mount chopper, the blades of the chopper assembly rotate about an axis that is perpendicular to the direction of travel. In such an arrangement, the chopped material is thrown directly into fins that deflect the chopped material in an attempt to evenly cover the full header width as the chopped material is disbursed behind the combine harvester. As will be clear in the following description, certain embodiments of a straw chopper rotor apparatus address one or more shortcomings of existing designs.

The following detailed description refers to the accompanying drawings. Wherever possible, the same reference numbers are used in the drawings and the following description to refer to the same or similar elements. While certain embodiments of the disclosure may be described, modifications, adaptations, and other implementations are possible as should be understood by one having ordinary skill in the art in the context of the disclosure. For example, substitutions, additions, or modifications may be made to the elements illustrated in the drawings, and the methods described herein may be modified by substituting, reordering, or adding stages to the disclosed methods. References hereinafter made to certain directions, such as, for example, “front”, “rear”, “left” and “right”, are made as viewed from the rear of the combine harvester looking forwardly.

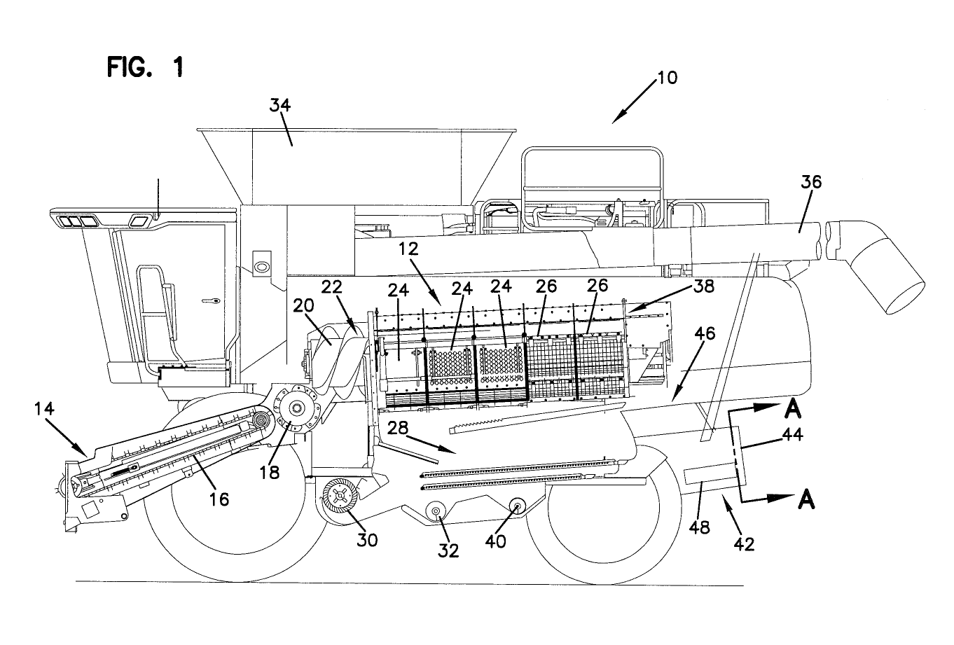

Referring to FIG. 1, shown is an example combine harvester 10 in which an embodiment of a straw chopper apparatus may be employed. It should be understood by one having ordinary skill in the art, in the context of the present disclosure, that the example components illustrated in FIG. 1 are merely illustrative, and should not be construed as implying any limitations upon the scope of the disclosure. For instance, though referred to as a straw chopper apparatus 10, it should be understood within the context of the present disclosure that residue other than straw may be received and processed by the straw chopper apparatus 10. The use of the term “straw” herein includes straw and/or other residue. The example combine harvester 10 selected for illustration in FIG. 1 has a single axial thresher rotor apparatus 12 that extends generally parallel with the path of travel of the machine. However, as will be seen, the principles of the present disclosure are not limited to combine harvesters with a thresher rotor apparatus 12 designed for axial flow, nor to axial flow, combine harvesters 10 having only a single such thresher rotor apparatus 12. For instance, the straw chopper apparatus 10 may be configured for use with many different combine configurations, including hybrid configurations (e.g., one or more axial rotors following a transverse threshing cylinder, a conventional configuration with axially operating straw walkers that transport the straw rearward from the same transverse threshing cylinder as in the hybrid, a twin-rotor configuration with side-by-side axial rotors, and other configurations, hybrid or otherwise, that may use some configuration of some or all of the all of the above components. Further, though in some embodiments, plural thresher rotor apparatuses may be employed, for the sake of simplicity in explaining the principles of the present disclosure, this specification will proceed utilizing a single axial flow thresher rotor apparatus 12 as the primary example.

As should be well understood by those skilled in the art, in this illustrated example, the combine harvester 10 includes a harvesting header (not shown) at the front of the machine that delivers collected crop materials to the front end of a feeder house 14. Such materials are moved upwardly and rearwardly within feeder house 14 by a conveyer 16 until reaching a beater 18 that rotates about a transverse axis. The beater 18 feeds the material upwardly and rearwardly to a rotary processing device, in this instance to a combine rotor 22 (also referred to herein as a thresher rotor) having an infeed auger 20 on the front end thereof. The auger 20, in turn, advances the materials axially into the thresher rotor apparatus 12 for threshing and separating. In other types of systems, the conveyor 16 may deliver the crop directly to a threshing cylinder.

Generally speaking, the crop materials entering the thresher rotor apparatus 12 move axially and helically therethrough during threshing and separating operations. During such travel the crop materials are threshed and separated by the thresher rotor 22 operating in cooperation with, for instance, foraminous processing members in the form of threshing concave assemblies 24 and separator grate assemblies 26, with the grain escaping laterally through the concave assemblies 24 and the grate assemblies 26 into a cleaning apparatus 28. Bulkier stalk and leaf materials are generally retained by the concave assemblies 24 and the grate assemblies 26 and are disbursed out the rear of thresher rotor apparatus 12 and ultimately out of the rear of the machine. A blower 30 forms part of the cleaning apparatus 28 and provides a stream of air throughout the cleaning region below the thresher rotor apparatus 12 and directed out the rear of the machine so as to carry lighter chaff particles away from the grain as it migrates downwardly toward the bottom of the machine to a clean grain auger 32. The auger 32 delivers the clean grain to an elevator (not shown) that elevates the grain to a storage bin 34 on top of the machine, from which it is ultimately unloaded via an unloading spout 36. A returns auger 40 at the bottom of the cleaning region is operable in cooperation with other mechanisms (not shown) to reintroduce partially threshed crop materials into the front of thresher rotor apparatus 12 for an additional pass through the system.

Having described pertinent parts of the combine harvester 12, attention is now directed toward the rear of the machine and in particular, the straw chopper apparatus 42. The straw chopper apparatus 42 comprises a housing 44 (also referred to as an enclosure) that surrounds (at least partially) plural rotors (not shown in FIG. 1) that each have a shaft with a respective axis of rotation that is arranged generally or substantially parallel to the direction of travel. In one embodiment, substantially parallel refers to an arrangement where the axis of rotation of each of the plural rotors is parallel to the direction of travel. In some embodiments, substantially refers to a variance of a few degrees (e.g., either direction) from exactly parallel. In some embodiments, the axis of rotation of each of the plural rotor shafts is referenced with respect to a longitudinal axis of the thresher rotor 22. For instance, in one embodiment, the axis of rotation of the rotor shaft is parallel to the longitudinal axis of the thresher rotor 22. In some embodiments, as another example, the axis of rotation of the rotor shaft is within a few degrees in either direction relative to parallel when compared to the longitudinal axis of the thresher rotor 22.

The housing 44 also comprises an inlet 46 that is beneath at least a portion of the thresher rotor apparatus 12, the inlet 46 defined by an opening suitable to receive, primarily, the threshed material (e.g., residue, such as straw), among other material in some instances. The housing 44 further comprises a set of outlets 48 (one shown), each outlet 48 defining an opening in the housing and located toward the lower end of the housing 44 and approximately equidistant from the bottom of the housing 44, though not limited to an equidistant arrangement. Note that in some embodiments, there may be fewer or a greater number of outlets of the same or different dimensions, or that in some embodiments, the outlets 48 may be positioned elsewhere.

In some embodiments, variations of the above are contemplated. For instance, in some embodiments, the housing 44 may be coupled to, or integrated with, a chopper deflector that resides above the discharge opening and acts to put a ceiling on the stream of flow of residue such that the residue does not go upward. In other words, the residue is driven more downward and less likely to be whipped by the wind up into the cooling system, or just generally up into the environment air. In such embodiments, the straw chopper apparatus 42 omits deflector fins, though in some embodiments, such fins may be used in addition to the ceiling deflector. Further, though shown as generally rectangular in geometry, the outlets 48 may be configured in one of a plurality of different geometric configurations. For instance, to meter the flow of material uniformly onto the ground, the discharge opening 48 through which the material exits the chopper housing 44 may not be a purely rectangular opening, but rather helically parallel or even triangular in some embodiments. For instance, the geometry of the outlet 48 may be configured such that material (e.g., residue) that exits, for instance, the front part of the outlet 48 may be propelled more horizontally and thus further out from the machine (e.g., sideways), whereas the material exiting the rear part of the outlet opening may be directed more downward, and therefore fall closer to the path of the combine harvester 10.

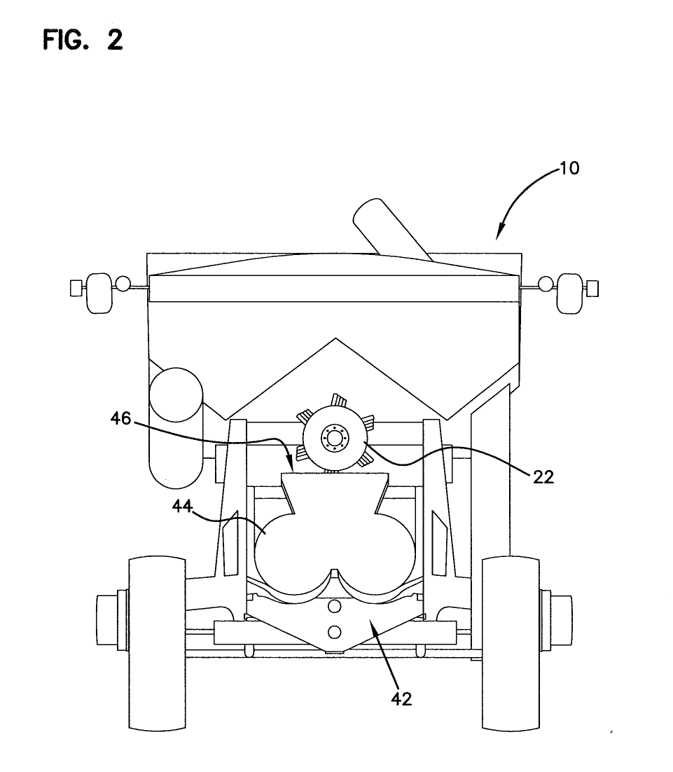

A rearward, elevation view of the straw chopper apparatus 42, and in particular, the housing 44, is shown in FIG. 2. Note that certain features described in FIG. 1 are omitted from FIGS. 2-6 to facilitate the understanding of the straw chopper apparatus 42. The straw chopper apparatus 42 is positioned, in one embodiment, directly beneath a portion of the rotor 22 (or thresher rotor apparatus 12). The housing 44 is generally geometrically shaped in one embodiment, with a wide entrance at the inlet 46 for receiving the threshed material, the inlet 46 generally narrowing toward the end closest to the rotors, where the housing 44 widens in cylindrical fashion to enclose and support the rotors. Note that the configuration of the housing 44 shown in FIG. 2 is merely illustrative, and other configurations may be used in some embodiments as should be understood by one having ordinary skill in the art. For instance, in some embodiments, the inlet 46 may widen as it approaches the rotors of the straw chopper apparatus 42, such as to mitigate possible plugging risks.

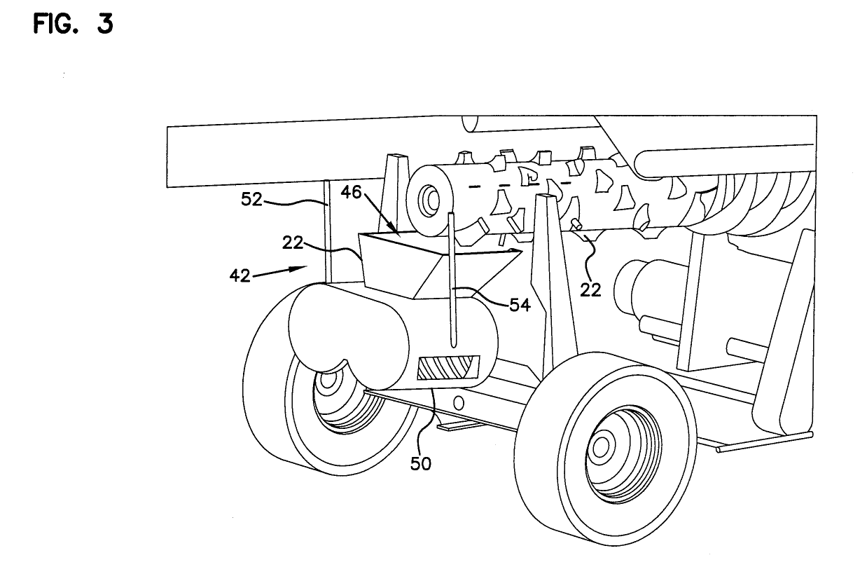

Referring to FIG. 3, shown is a partial, rearward and right-side perspective illustration of the straw chopper apparatus 42, which illustrates the other outlet 50 of the housing 44 and the relative placement of the inlet 46 and a portion of the rotor 22. As indicated above, some embodiments of the chopper rotor apparatus 42 may incorporate a “ceiling” deflector. Support member 52 and 54, shown in partial view, attach the straw chopper apparatus 42 to the frame of the combine harvester 10. Attachment may be accomplished by weld, bolts, or other known mechanisms of attachment.

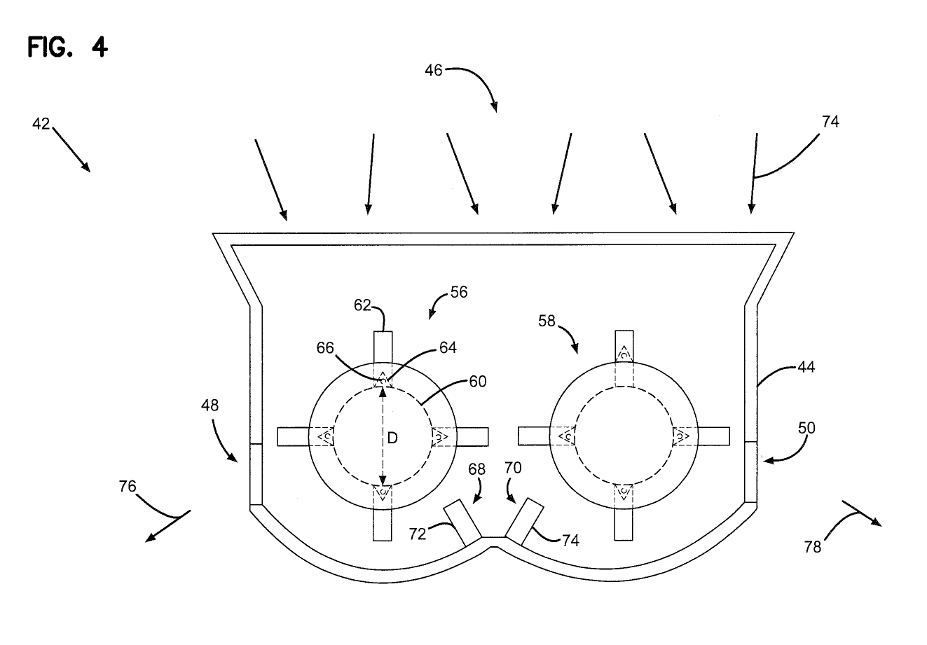

FIG. 4 is a block diagram that illustrates an end, partial cross sectional view of the straw chopper apparatus 42 along A-A (FIG. 1). Note that components shown in this and other figures of the disclosure are not necessarily to scale. The straw chopper apparatus 42 comprises a housing 44 with an inlet 46 and two outlets 48 and 50. The straw chopper apparatus 42 further comprises, in the illustrated embodiment, two (2) chopper rotors 56 and 58 located side-by-side, each having a defined diameter, D. The chopper rotors 56 and 58 may be powered by the PTO, such as via an intermediate device(s) (e.g., gear assembly) and driveline (not shown) as should be understood by one having ordinary skill in the art in the context of the present disclosure. Referring to chopper rotor 56, with the understanding that similar features apply to chopper rotor 58, the chopper rotor 56 comprises a shaft 60 shown in phantom behind an end plate, shown as circular in geometric configuration in FIG. 4. The shaft 60 may comprise a tube in some embodiments. Omitted from FIG. 4 are bearings that slide over the shaft stubs protruding from the respective end plates. The shaft 60 further comprises plural blades 62 (e.g., knives, etc.) attached thereto, the plural blades 62 circumferentially arranged around the shaft 60.

When viewed from one end (the end shown in FIG. 4) of the shaft 60 to the opposite end (not shown in FIG. 4) of the shaft 60, the blades may be offset 90° from one blade (or set of blades, explained below) to the next, though not limited to 90°. For instance, starting from the end of the shaft 60 closes to the end of the combine 10, there may be a first blade 62 (or set of blades) coupled to the shaft at the 12:00 location (e.g., using a clock face analogy). Advancing further away from the shown end of the shaft 60 to the next blade, there may be a blade 62 coupled to the shaft 60 at the 3:00 position of the shaft. Advancing still further away from the shown end of the shaft 60 to the next blade, there may be a blade 62 coupled to the shaft at the 6:00 position, and so on. Variations of this arrangement are contemplated to be within the scope of the disclosure, including arrangement without the offset along the length of the shaft 60.

As indicated above, in some embodiments, there may be a second blade (obscured by the first blade 62 shown in this rearward view in FIG. 4) at each of the different blade positions, the blade 62 and the second blade comprising a set of blades at each position. In one embodiment, each blade 62 is pivotably coupled to a protrusion 64 (e.g., a welded piece, such as a flange, or casted protrusion, etc.) of the shaft 60, the protrusion (and each blade) comprising an opening through which a coupling mechanism 66 (e.g., coupling pin or bolt, washer, bushing, etc.) is inserted therethrough to enable pivotal movement of each respective blade 62 of the set. Although the blades 62 are described as pivotably attached to the shaft 60, in some embodiments, the blades 62 may be rigidly affixed to the shaft 60.

The housing 44 further comprises one or more shear bar apparatuses 68 and 70 coupled in one embodiment, as illustrated in FIG. 4, to the lower inside surface of the housing. In one embodiment, the shear bar apparatuses 68 and 70 (collectively or individually also referred to herein as a shearing apparatus) each comprise plural shear bars, one from each shown and referenced respectively as shear bar 72 and shear bar 74. In some embodiments, the shear bar apparatuses 68 and 70 may be coupled to the lower outside surface of the housing 44, where each of the plural shear bars, such as shear bars 72 and 74, extend through openings or slots in the housing 44 to allow the shear bars 68 and 72 to extend through the housing and into the internal space between the inside, bottom curved surface of the housing and between a portion of the length of two blades from each set of blades of the rotors 56 and 58. In the embodiment illustrated in FIG. 4, the shear bars 72 and 74 extend internally outward from the curved, lower internal surface of the housing 44 and into a space between each blade 62 of the chopper rotors 56 and 58. In some embodiments, the shear bar apparatuses 68 and 70 may be located elsewhere within the internal space of the housing, such as attached by a frame member having an axis running vertically and located equidistantly between the two chopper rotors 56 and 58, among other configurations. Further, in some embodiments, the shear bar apparatuses 68 and 70 may be extendable and retractable (e.g., via operator control or automatically based on feedback sensing) to enable control of the severity of the chop.

It should be appreciated within the context of the present disclosure that variations of the housing 44 and/or associated components shown therein are contemplated to be within the scope of the disclosure. For instance, in some embodiments, the shear bar apparatuses 68 and 70 may be replaced with a shearing apparatus comprising stationary knives that protrude high enough to enable the blades 62 (e.g., a set of swinging knives in some embodiments) to shear against the stationary knives. Like the shear bar apparatuses 68 and 70, the stationary knives in such an embodiment may be extendable or retractable to, for instance, control the severity of the chop.

In operation, the threshed material (which may include other material to some degree depending on the conditions of the crop and environment and the efficiency of the components of the combine harvester, among other factors) enters the inlet 46 from the thresher rotor apparatus (not shown), as illustrated by the arrows 74, and is chopped by each of the pivoting (or in some embodiments, fixed) blades 62 in conjunction with the shear bars 72 and 74 (or in some embodiments, stationary knives) as the chopper rotors 56 and 58 rotate (e.g., as their respective shafts 60 rotate) about their respective axis of rotation. The chopped material, represented by arrows 76 and 78, are discharged through the outlets 48 and 50 and disbursed directly (and possibly deflected to hinder upward movement in some embodiments) to the ground along the width of the combine header.

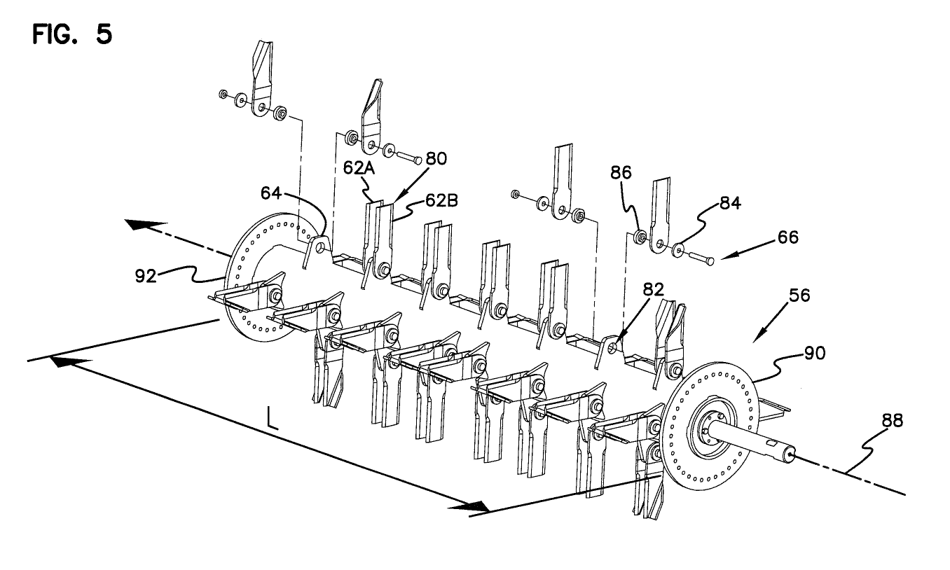

FIG. 5 shows an example chopper rotor 56 using plural sets of blades, such as set 80 comprising a first blade 62A and a second blade 62B. In one embodiment, each blade, such as blade 62A, is pivotably coupled (though in some embodiments, may be fixed) to the protrusion 64 by the coupling mechanism 66. The example coupling mechanism 66 illustrated in FIG. 5 comprises a hex bolt that is inserted in the slot or opening 82 of the protrusion 64 and through the slots or openings of each blade of the set 80, and in some embodiments pivotably secured to the blades 62 by a respective washer 84 and bushing 86 pair. It should be appreciated that other mechanisms of pivotal attachment are contemplated to be within the scope of the disclosure. Further, though shown using two pivotal blades 62A and 62B per set 80, a single blade or additional blades may comprise a set in some embodiments.

Note also that the chopper rotor 56 has an axis of rotation 88, and a length, L. The chopper rotor 56 further comprises a bearing proximal to each end of the shaft (not shown) between each respective end of the shaft 60 and respective end plates 90 and 92. With continued reference to FIGS. 4-5, it is noted that each chopper rotor 56, 58 is generally characterized by a length dimension, L, that is greater than the diameter dimension, D. For instance, in one embodiment, the length dimension may be approximately 3 ft. (feet) and the diameter dimension may be 1 ft., though not limited to these dimensions or ratios.

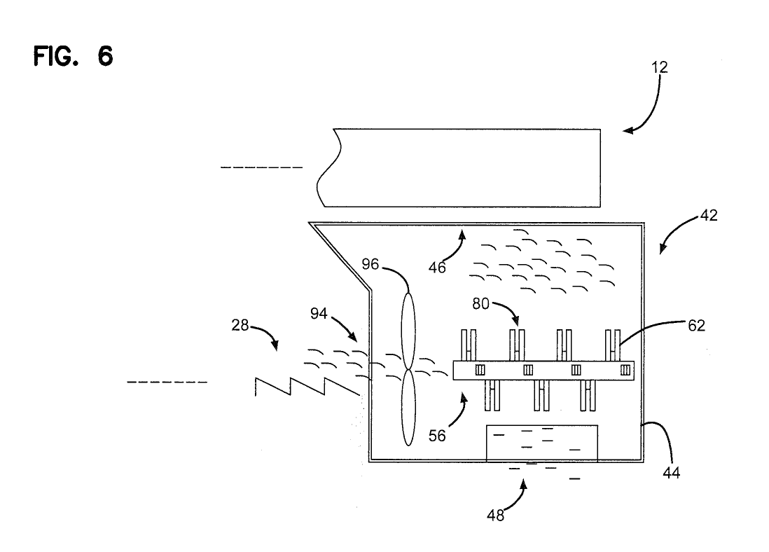

FIG. 6 is a block diagram that shows an optional, second inlet 94 and a fan apparatus 96 to cause movement of air that acts to draw or induce cleaned material (e.g., chaff) from the cleaning apparatus 28 and into the chopper rotors 56 (and/or 58). For instance, as shown, the threshed material is received from the thresher rotor apparatus 12 through the top inlet 46 of the straw chopper apparatus 42 and is chopped by the blades 62 of each set 80 of the chopper rotors, such as chopper rotor 56, in conjunction with the respective shearing apparatuses 68 and 70 (omitted from FIG. 6 to avoid unduly complicating the drawing). Though not shown, it should be appreciated that each shear bar is disposed between each blade to facilitate the chopping of the material by the pivotal blades.

In some embodiments, such as the illustrated embodiment shown in FIG. 6, an optional second inlet 94 is disposed at the front of the housing 44, wherein the second inlet is defined by an opening that allows the flow of material from the cleaning apparatus 28 to one or more of the chopper rotors, such as chopper rotor 56. In one embodiment, a fan apparatus 96 (represented graphically in FIG. 6 as a blade, with the understanding that the fan apparatus 96 comprise an assembly of a fan housing with a motor, fan rotor, and plural blades that rotate by virtue of rotation of the rotor) is disposed within the housing 44 and disposed between the cleaning apparatus 28 and the chopper rotor 56 to draw the material from the cleaning apparatus, through the second inlet 96, and into the chopper rotor 56 to be chopped along with the threshed material from the thresher rotor apparatus 12. In some embodiments, the fan apparatus 96 comprises an axial pan impellor or propeller comprised of a plurality of blades on a central hub.

The fan apparatus 96 may comprise one of a plurality of different and known fan blade types, including bladeless fans, centrifugal fans, among others, and may be driven via a suitable driveline arrangement (not shown, but disposed along the outside of the combine harvester 10 in one embodiment, among other arrangements) powered by the PTO or by other powering mechanisms. Though illustrated as located within the housing 44, in some embodiments, the fan apparatus 96 may be located external to the housing, wherein the air is ducted as needed to induce the material from the cleaning apparatus 28 into the chopper rotor blades 62.

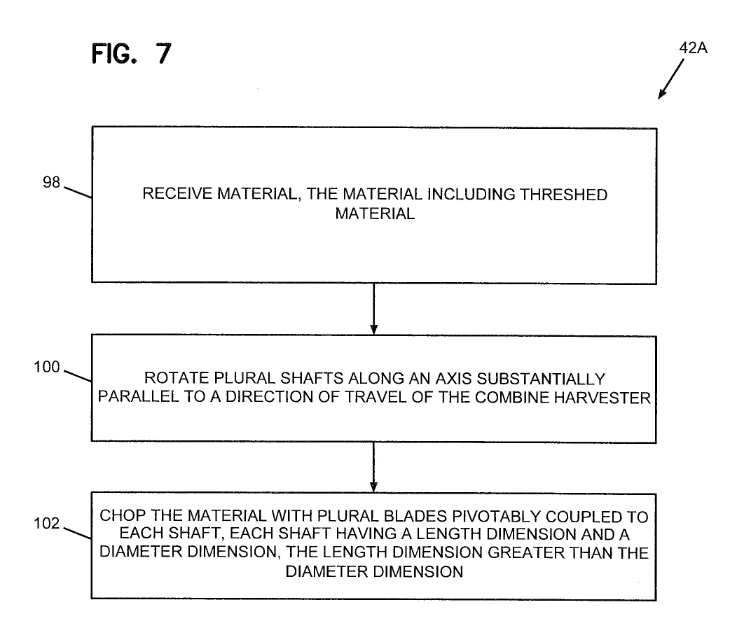

Having described certain embodiments of a straw chopper apparatus 42, it should be appreciated that one chopper method embodiment 42A, illustrated in FIG. 7, comprises receiving material, the material including threshed material (98), rotating plural shafts along an axis substantially parallel to a direction of travel of the combine harvester (100), and chopping the material with plural blades pivotably coupled to each shaft, each shaft having a length dimension and a diameter dimension, the length dimension greater than the diameter dimension (102).

It should be emphasized that the above-described embodiments of the present disclosure are merely possible examples of implementations, merely set forth for a clear understanding of the principles of straw chopper apparatus embodiments. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A straw chopper apparatus of a combine harvester, the straw chopper apparatus comprising:
plural chopper rotors disposed proximally to a rearward end of the combine harvester, each of the chopper rotors comprising a shaft having an axis of rotation substantially parallel to the direction of travel, the shaft having a length dimension and a diameter dimension, the length dimension greater than the diameter dimension, the shaft comprising plural sets of blades that are pivotably coupled to the shaft.

2. The straw chopper apparatus of claim 1, wherein the shaft comprises bearings at each end of the shaft.

3. The straw chopper apparatus of claim 1, wherein the axis of rotation is parallel to the direction of travel.

4. The straw chopper apparatus of claim 1, wherein the plural sets of blades comprise a first set of blades and a second set of blades, the first set comprising two blades separated by a first protrusion of the shaft, the second set comprising two blades separated by a second protrusion of the shaft, the first and second protrusions coupled respectively to the first and second set of blades via a respective coupling mechanism for each set.

5. The straw chopper apparatus of claim 4, further comprising a housing supporting and at least partially surrounding the plural chopper rotors, the housing connected to the combine harvester, the housing comprising a first shearing apparatus and a second shearing apparatus connected to the housing, each of the shearing apparatuses comprising one of swinging knives or plural shear bars, wherein at least one of the swinging knives or one of the plural shear bars is capable of occupying an area defined in part by the two blades of each of the respective first and second sets, the at least one of the swinging knives or one of the plural shear bars located between the two blades.

6. The straw chopper apparatus of claim 1, further comprising a housing supporting, and at least partially surrounding, the plural chopper rotors, the housing connected to the combine harvester, the housing comprising a first inlet suitably located beneath at least a portion of a thresher rotor apparatus of the combine harvester to receive material through an opening defined by the first inlet from the thresher rotor apparatus, the thresher rotor apparatus comprising at least one thresher rotor.

7. The straw chopper apparatus of claim 6, wherein a longitudinal axis of the thresher rotor relative to the direction of travel is parallel to the axis of rotation.

8. The straw chopper apparatus of claim 6, wherein at least a portion of the first inlet is located directly beneath the portion of the thresher rotor.

9. The straw chopper apparatus of claim 6, wherein the housing further comprises a second inlet configured to receive material through an opening defined by the second inlet from a cleaning apparatus of the combine harvester.

10. The straw chopper apparatus of claim 9, further comprising a fan apparatus located in front of the plural chopper rotors, the fan apparatus configured to induce movement of the material from the cleaning apparatus to at least one of the plural chopper rotors.

11. The straw chopper apparatus of claim 6, wherein the housing further comprises one or more outlets configured to discharge chopped material through openings defined by the one or more outlets, the material chopped by the plural chopper rotors.

12. The straw chopper apparatus of claim 1, wherein chopped material is dispersed to the ground evenly along the full width of a header of the combine harvester.

13. A straw chopper apparatus of a combine harvester, the straw chopper apparatus comprising:
a housing connected to the combine harvester, the housing comprising a top inlet that is configured to receive threshed material from a thresher rotor apparatus of the combine harvester, the housing further comprising:
a first chopper rotor comprising a first shaft having an axis of rotation parallel to a longitudinal axis of a thresher rotor of the thresher rotor apparatus; and
a second chopper rotor comprising a second shaft having an axis of rotation parallel to the longitudinal axis of the thresher rotor,
wherein each shaft has a length dimension and a diameter dimension, the length dimension greater than the diameter dimension,
wherein each shaft comprises plural blades coupled to the shaft.

14. The straw chopper apparatus of claim 13, wherein the housing further comprises plural shearing apparatuses disposed proximal to the first and second chopper rotors.

15. The straw chopper apparatus of claim 13, wherein the housing further comprises a second inlet disposed in a plane that is different than a plane coincident with the first inlet, the second inlet suitably located to receive material from a cleaning apparatus of the combine harvester.

16. The straw chopper apparatus of claim 13, wherein the housing further comprises a fan apparatus disposed proximal to an entrance of the first and second chopper rotors, the fan apparatus configured to draw the material from the cleaning apparatus to the first and second chopper rotors.

17. The straw chopper apparatus of claim 13, wherein the housing further comprises one or more outlets configured to discharge chopped material through openings defined by the one or more outlets, the material chopped by the plural chopper rotors.

18. The straw chopper apparatus of claim 13, wherein chopped material is dispersed to the ground evenly along the full width of a header of the combine harvester.

19. The straw chopper apparatus of claim 13, wherein the plural blades are arranged circumferentially around each shaft and distributed along the length of each shaft.

20. A chopping method in a combine harvester, the method comprising:
receiving material, the material including threshed material;
rotating a first shaft in a first direction along an axis substantially parallel to a direction of travel of the combine harvester to chop the material with plural blades pivotably coupled to the first shaft and to disperse material into the first direction;
rotating a second shaft in a second direction along an axis substantially parallel to the direction of travel of the combine harvester to chop the material with plural blades pivotably coupled to the second shaft and to disperse material into the second direction; and
directing dispersed material in the first and second directions evenly along the full width of a header of the combine harvester.
